(19) United States
(12) Patent Application Publication
(10) Pub. No.: US 2023/0198409 A1
(43) Pub. Date: Jun. 22, 2023

(54) Method for Modulating Switch of Converter

(71) Applicants: Tianjin ChengJian University, Tianjin (CN); Hebei University of Science and Technology, Shijiazhuang (CN); Hebei University of Technology, Tianjin (CN)

(72) Inventors: Lei PAN, Tianjin (CN); Hexu SUN, Shijiazhuang (CN); Yan DONG, Tianjin (CN); Yi PANG, Tianjin (CN); Jingmei ZHANG, Tianjin (CN); Jianwei CHEN, Tianjin (CN); Weilin LI, Tianjin (CN); Aosen HU, Tianjin (CN)

(21) Appl. No.: 17/876,590

(22) Filed: Jul. 29, 2022

(30) Foreign Application Priority Data
Dec. 16, 2021 (CN) 202111547751.1
Dec. 16, 2021 (CN) 202111547769.1

(51) Int. Cl. H02M 3/158; H02M 1/14; H02M 1/088

(52) U.S. Cl. CPC H02M 3/1586; H02M 1/14; H02M 1/088

(57) ABSTRACT

The present disclosure discloses a method for modulating a switch of a converter. The method is applicable to a topological structure of a multiphase stacked interleaved buck converter, and includes: acquiring charge-discharge state information in the topological structure, wherein the charge-discharge state information comprises at least a first charge-discharge state of any one phase primary loop, a second charge-discharge state of a secondary loop corresponding to the any one phase primary loop, a third charge-discharge state of another primary loop, and a fourth charge-discharge state of another secondary loop; and adjusting, based on the first charge-discharge state, a closed state of a switch disposed on a bridge arm connected to the any one phase primary loop, and adjusting, based on the second charge-discharge state and the third charge-discharge state, a closed state of a switch disposed on another bridge arm.

### TECHNICAL FIELD

The present disclosure relates to the field of converter control, and specifically, to a method for modulating a switch of a converter.

### BACKGROUND

A method for modulating a switch of an interleaved converter in the related art is mainly applicable to a conventional two-phase interleaved parallel buck converter, single-phase stacked interleaved buck converter, and the like. As shown in FIG. 1 and FIG. 2, each switch is configured to control a charge state or a discharge state of an inductor respectively. The above method needs to gradually analyze an inductance state to obtain a state of the switch, resulting in low operation efficiency of the interleaved converter.

For example, the interleaved parallel buck converter adopts two bridge arms and four switches. As shown in FIG. 1, since the switches of the interleaved parallel buck converter are conducted in an interleaved manner during operation, the above interleaved parallel buck converter can completely cancel output ripples only when a duty cycle is 50%. As a result, such a converter has a certain limitation and relatively low operation efficiency. A stacked interleaved buck converter also adopts two bridge arms and four switches. As shown in FIG. 2, a direct current of a secondary loop is isolated due to the existence of a capacitor of the secondary loop, so that a current flowing through a primary loop equals a load current, but the current stress flowing through the four switches increases simultaneously, and the operation efficiency of the interleaved converter is also reduced. In addition, when one bridge arm fails, the topological structure of the stacked interleaved buck converter cannot be operated properly, so that such an interleaved converter has a certain limitation.

In view of the above problems, no effective solution has been proposed yet.

### SUMMARY

An embodiment of the present disclosure provides a method for modulating a switch of a converter, to at least resolve the technical problem that a conventional method for modulating a switch of an interleaved converter needs to gradually analyze the charge and discharge of a plurality of inductors, resulting in low operation efficiency of the converter.

An aspect of an embodiment of the present disclosure provides a method for modulating a switch of a converter. The method is applicable to a topological structure of a multiphase stacked interleaved buck converter. The topological structure includes a first number of primary loops, the first number of secondary loops, and the first number of bridge arms. Each bridge arm is provided with a second number of switches. The method includes: acquiring charge-discharge state information in the topological structure, where the charge-discharge state information includes at least a first charge-discharge state of any one phase primary loop, a second charge-discharge state of a secondary loop corresponding to the any one phase primary loop, a third charge-discharge state of another primary loop, and a fourth charge-discharge state of another secondary loop; and adjusting, based on the first charge-discharge state, a closed state of a switch disposed on a bridge arm connected to the any one phase primary loop, and adjusting, based on the second charge-discharge state and the third charge-discharge state, a closed state of a switch disposed on another bridge arm.

Another aspect of an embodiment of the present disclosure further provides an apparatus for modulating a switch of a converter. The apparatus is applicable to the topological structure of a multiphase stacked interleaved buck converter. The topological structure includes a first number of primary loops, the first number of secondary loops, and the first number of bridge arms. Each bridge arm is provided with a second number of switches. The apparatus includes: an acquisition module, configured to acquire charge-discharge state information in the topological structure, where the charge-discharge state information includes at least a first charge-discharge state of any one phase primary loop, a second charge-discharge state of a secondary loop corresponding to the any one phase primary loop, a third charge-discharge state of another primary loop, and a fourth charge-discharge state of another secondary loop; and an adjustment module, configured to adjust, based on the first charge-discharge state, a closed state of a switch disposed on a bridge arm connected to the any one phase primary loop, and adjust, based on the second charge-discharge state and the third charge-discharge state, a closed state of a switch disposed on another bridge arm.

Another aspect of an embodiment of the present disclosure further provides a non-volatile storage medium. The non-volatile storage medium stores a plurality of instructions. The above instructions are loaded by a processor to execute any one of the above method for modulating a switch of a converter.

Another aspect of an embodiment of the present disclosure further provides an electronic device, including a memory and a processor. The memory stores a computer program. The processor is configured to run the computer program to execute any one of the above method for modulating a switch of a converter.

An aspect of an embodiment of the present disclosure provides a multiphase stacked interleaved buck converter, including: a first number of primary loops; a first number of secondary loops, connected to the first number of primary loops and configured to eliminate current ripples in the loops; and a first number of bridge arms, connected to the first number of primary loops and the first number of secondary loops, and configured to control charge-discharge states of the first number of primary loops and the first number of secondary loops.

As at least one alternative embodiment, the first number of bridge arms include: a second number of bridge arm switches, configured to control the charge-discharge states of the first number of primary loops and the first number of secondary loops based on switch states of the bridge arm switches.

As at least one alternative embodiment, the first number of bridge arms include the following. The number of bridge arm switches on each bridge arm is same, and time periods that different bridge arm switches disposed on each bridge arm are in an off state are different.

As at least one alternative embodiment, each primary loop includes at least an inductor. The inductor and a load are serially connected to the primary loop. Each secondary loop includes at least the inductor and a capacitor. The inductor and the capacitor are serially connected to the secondary loop.

As at least one alternative embodiment, the current ripple is further configured to determine an inductance parameter of the inductor within a target time period. An equation of the current ripple within the target time period is

$$Δ i = \frac{D ( 1 - D )}{f L} {V}_{IN} .$$

Δi is the current ripple, D is a duty cycle of the multiphase stacked interleaved buck converter, f is a switching frequency of a switch of the multiphase stacked interleaved buck converter, L is the inductor, and V_{IN} is an input voltage of the multiphase stacked interleaved buck converter.

Another aspect of an embodiment of the present disclosure provides a three-phase stacked interleaved buck converter, including: three primary loops; three secondary loops, connected to the three primary loops and configured to eliminate-current ripples in the loops; and three bridge arms, connected to the three primary loops and the three secondary loops, and configured to control charge-discharge states of the three primary loops and the three secondary loops.

As at least one alternative embodiment, each of the three bridge arms includes: three bridge arm switches, configured to control the charge-discharge states of the three primary loops and the three secondary loops based on switch states of the bridge arm switches. The three bridge arm switches cannot be in an off state at the same time.

Another aspect of an embodiment of the present disclosure provides a topological structure of a two-phase stacked interleaved buck converter, including: two primary loops; two secondary loops, connected to the two primary loops and configured to eliminate current ripples in the loops; and two bridge arms, connected to the two primary loops and the two secondary loops, and configured to control charge-discharge states of the two primary loops and the two secondary loops.

As at least one alternative embodiment, each of the two bridge arms includes: three bridge arm switches, configured to control the charge-discharge states of the two primary loops and the two secondary loops based on switch states of the bridge arm switches. The three bridge arm switches cannot be in an off state at the same time.

In the embodiments of the present disclosure, the charge-discharge state information in the topological structure is acquired. The charge-discharge state information includes at least the first charge-discharge state of any one phase primary loop, the second charge-discharge state of the secondary loop corresponding to the any one phase primary loop, the third charge-discharge state of another primary loop, and the fourth charge-discharge state of another secondary loop. The closed state of the switch disposed on the bridge arm connected to the any one phase primary loop is adjusted based on the first charge-discharge state, and the closed state of the switch disposed on another bridge arm is adjusted based on the second charge-discharge state and the third charge-discharge state. Therefore, a purpose of simultaneously controlling the charge and discharge of the plurality of inductors can be achieved, and the technical effect of enhancing the operation efficiency of the converter can be realized, thereby resolving the technical problem that a conventional method for modulating a switch of an interleaved converter needs to gradually analyze the charge and discharge of a plurality of inductors, resulting in low operation efficiency of the converter.

### BRIEF DESCRIPTION OF THE DRAWINGS

The accompanying drawings described herein are used to provide a further understanding of the present disclosure, and constitute a part of this application. The exemplary embodiments of the present disclosure and the description thereof are used to explain the present disclosure, but do not constitute improper limitations to the present disclosure. In the drawings:

FIG. 1 is a schematic diagram of a circuit structure of a conventional two-phase interleaved parallel buck converter in the related art.

FIG. 2 is a schematic diagram of a circuit structure of a single-phase stacked interleaved buck converter in the related art.

FIG. 3 is a flowchart of a method for modulating a switch of a converter according to an embodiment of the present disclosure.

FIG. 4a is a schematic diagram of an optional circuit structure configured to implement the above method for modulating a switch according to an embodiment of the present disclosure.

FIG. 4b is a schematic diagram of another optional circuit structure configured to implement the above method for modulating a switch according to an embodiment of the present disclosure.

FIG. 5 is a flowchart of an optional method for modulating a switch of a converter according to an embodiment of the present disclosure.

FIG. 6 is a schematic diagram of another optional circuit structure configured to implement the above method for modulating a switch according to an embodiment of the present disclosure.

FIG. 7 is a flowchart of another method for modulating a switch of a converter according to an embodiment of the present disclosure.

FIG. 8 is a schematic diagram of another optional circuit structure configured to implement the above method for modulating a switch according to an embodiment of the present disclosure.

FIG. 9 is a flowchart of another optional method for modulating a switch of a converter according to an embodiment of the present disclosure.

FIG. 10 is a schematic diagram of another optional circuit structure configured to implement the above method for modulating a switch according to an embodiment of the present disclosure.

FIG. 11 is a schematic diagram of another optional circuit structure configured to implement the above method for modulating a switch according to an embodiment of the present disclosure.

FIG. 12 is a schematic diagram of another optional circuit structure configured to implement the above method for modulating a switch according to an embodiment of the present disclosure.

FIG. 13 is a schematic diagram of another optional circuit structure configured to implement the above method for modulating a switch according to an embodiment of the present disclosure.

FIG. 14 is a schematic diagram of another optional circuit structure configured to implement the above method for modulating a switch according to an embodiment of the present disclosure.

FIG. 15 is a schematic diagram of a topological structure of a multiphase stacked interleaved buck converter according to an embodiment of the present disclosure.

FIG. 16a is a schematic diagram of a topological structure of an optional three-phase stacked interleaved buck converter according to an embodiment of the present disclosure.

FIG. 16b is a schematic diagram of a topological structure of another optional three-phase stacked interleaved buck converter according to an embodiment of the present disclosure.

FIG. 16c is a schematic diagram of a topological structure of another optional three-phase stacked interleaved buck converter according to an embodiment of the present disclosure.

FIG. 16d is a schematic diagram of a topological structure of another optional three-phase stacked interleaved buck converter according to an embodiment of the present disclosure.

FIG. 16e is a schematic diagram of a topological structure of another optional three-phase stacked interleaved buck converter according to an embodiment of the present disclosure.

FIG. 17a is a schematic diagram of a topological structure of an optional two-phase stacked interleaved buck converter according to an embodiment of the present disclosure.

FIG. 17b is a schematic diagram of a topological structure of an optional two-phase stacked interleaved buck converter according to an embodiment of the present disclosure.

FIG. 17c is a schematic diagram of a topological structure of an optional two-phase stacked interleaved buck converter according to an embodiment of the present disclosure.

FIG. 17d is a schematic diagram of a topological structure of an optional two-phase stacked interleaved buck converter according to an embodiment of the present disclosure.

FIG. 18 is a schematic structural diagram of another optional apparatus for modulating a switch of a converter according to an embodiment of the present disclosure.

### DETAILED DESCRIPTION OF THE EMBODIMENTS

In order to enable those skilled in the art to better understand the solutions of the present disclosure, the technical solutions in the embodiments of the present disclosure will be clearly and completely described below in combination with the drawings in the embodiments of the present disclosure. It is apparent that the described embodiments are only part of the embodiments of the present disclosure, not all the embodiments. Based on the embodiments in the present disclosure, all other embodiments obtained by those of ordinary skilled in the art without creative work shall fall within the protection scope of the present disclosure.

It is to be noted that terms “first”, “second” and the like in the description, claims and the above mentioned drawings of the present disclosure are used for distinguishing similar objects rather than describing a specific sequence or a precedence order. It should be understood that the data used in such a way may be exchanged where appropriate, in order that the embodiments of the present disclosure described here can be implemented in an order other than those illustrated or described herein. In addition, terms “include” and “have” and any variations thereof are intended to cover non-exclusive inclusions. For example, it is not limited for processes, methods, systems, products or devices containing a series of steps or units to clearly list those steps or units, and other steps or units which are not clearly listed or are inherent to these processes, methods, products or devices may be included instead.

### Embodiment 1

A method for modulating a switch of an interleaved converter in the related art mainly relates to three converters, which are a conventional two-phase interleaved parallel buck converter, a stacked interleaved buck converter, and a multiphase stacked interleaved buck converter.

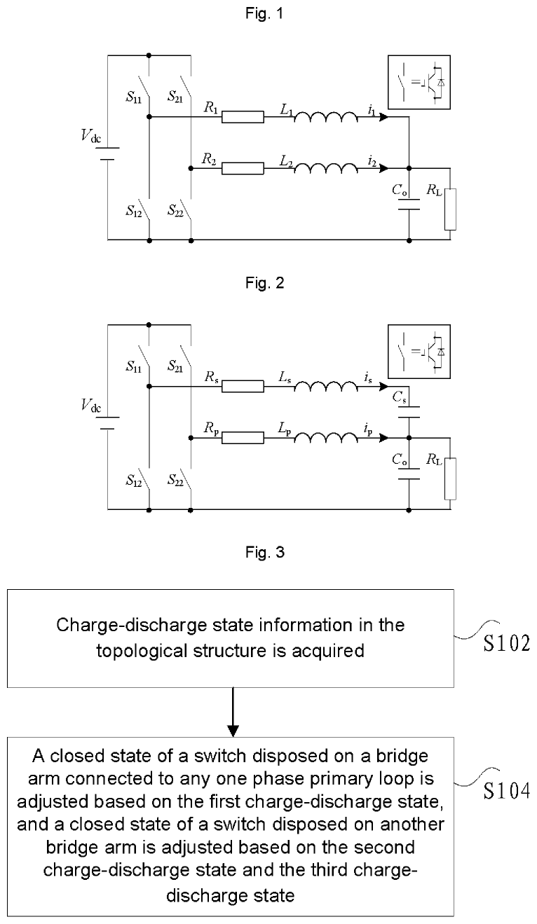

FIG. 1 is a schematic diagram of a circuit structure of a conventional two-phase interleaved parallel buck converter in the related art. As shown in FIG. 1, a switch sequence of the two-phase interleaved parallel buck converter is

$$[ \begin{matrix}{S}_{11} & {S}_{21} \\ {S}_{12} & {S}_{22}\end{matrix} ] .$$

A switch S₁₁ controls the charge of an inductor L1, a switch S₁₂ controls the discharge of the inductor L1, a switch S₂₁ controls the charge of an inductor L2, and a switch S₂₂ controls the discharge of the inductor L2. That is to say, each switch controls a charge state or a discharge state of one inductor. Therefore, an inductor state is required to be gradually analyzed to obtain states of the switches, resulting in low operation efficiency.

FIG. 2 is a schematic diagram of a circuit structure of a stacked interleaved buck converter in the related art. As shown in FIG. 2, a switch sequence of the stacked interleaved buck converter is

$$[ \begin{matrix}{S}_{11} & {S}_{21} \\ {S}_{12} & {S}_{22}\end{matrix} ] .$$

The switch S₁₁ controls the charge of the inductor L1, the switch S₁₂ controls the discharge of the inductor L1, the switch S₂₁ controls the charge of the inductor L2, and the switch S₂₂ controls the discharge of the inductor L2. In this way, each switch controls the charge state or the discharge state of one inductor. Therefore, the inductor state is required to be gradually analyzed to obtain the states of the switches, resulting in low operation efficiency.

In view of the above disadvantages, in the present disclosure, a method for modulating a parallel interleaved switch is provided based on a multiphase stacked interleaved topological structure. The charge and discharge of a plurality of inductors may be controlled by controlling the switching of the switches. Therefore, the time for analyzing the switch state can be reduced, and the operation efficiency of the converter can be greatly enhanced.

According to an embodiment of the present disclosure, a method embodiment for modulating a switch of a converter is provided. It is to be noted that the steps shown in the flowchart of the accompanying drawings may be executed in a computer system, such as a set of computer-executable instructions, and although a logical sequence is shown in the flowchart, in some cases, the steps shown or described may be executed in a different order than here.

FIG. 3 is a flowchart of a method for modulating a switch of a converter according to an embodiment of the present disclosure. As shown in FIG. 3, the method is applicable to a topological structure of a multiphase stacked interleaved buck converter. The topological structure includes a first number of primary loops, the first number of secondary loops, and the first number of bridge arms. Each bridge arm is provided with a second number of switches. The method includes the following steps.

At S102, charge-discharge state information in the topological structure is acquired. The charge-discharge state information includes at least a first charge-discharge state of any one phase primary loop, a second charge-discharge state of a secondary loop corresponding to any one phase primary loop, a third charge-discharge state of another primary loop, and a fourth charge-discharge state of another secondary loop.

At S104, a closed state of a switch disposed on a bridge arm connected to any one phase primary loop is adjusted based on the first charge-discharge state, and a closed state of a switch disposed on another bridge arm is adjusted based on the second charge-discharge state and the third charge-discharge state.

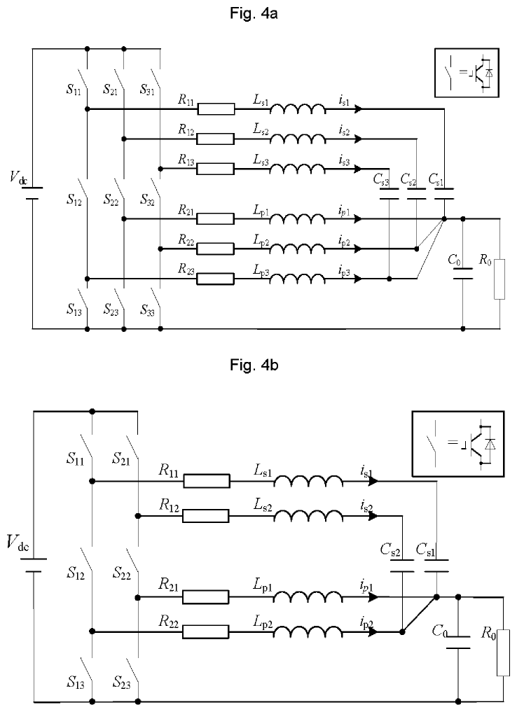

As at least one alternative embodiment, any primary loop corresponds to a secondary loop. As shown in FIG. 4a and FIG. 4b, an end of the secondary loop is connected to the bridge arm, and the other end of the secondary loop is connected to the corresponding primary loop. The primary loop and the bridge arm-connected end of the secondary loop corresponding to the primary loop are respectively connected to two different bridge arms.

In the embodiments of the present disclosure, the charge-discharge state information in the topological structure is acquired. The charge-discharge state information includes at least the first charge-discharge state of any one phase primary loop, the second charge-discharge state of the secondary loop corresponding to the any one phase primary loop, the third charge-discharge state of another primary loop, and the fourth charge-discharge state of another secondary loop. The closed state of the switch disposed on the bridge arm connected to the any one phase primary loop is adjusted based on the first charge-discharge state, and the closed state of the switch disposed on another bridge arm is adjusted based on the second charge-discharge state and the third charge-discharge state. Therefore, a purpose of simultaneously controlling the charge and discharge of the plurality of inductors can be achieved, and the technical effect of enhancing the operation efficiency of the converter can be realized, thereby resolving the technical problem that a conventional method for modulating a switch of an interleaved converter needs to gradually analyze the charge and discharge of a plurality of inductors, resulting in low operation efficiency of the converter.

In an optional embodiment, the step of acquiring the charge-discharge state information in the topological structure includes: determining the second charge-discharge state, the third charge-discharge state, and the fourth charge-discharge state based on the first charge-discharge state and a connection relationship between each loop and the first number of bridge arms.

As at least one alternative embodiment, the first charge-discharge state is same as the fourth charge-discharge state, and both the second charge-discharge state and the third charge-discharge state are opposite to the first charge-discharge state. For example, in a three-phase stacked interleaved topological structure shown in FIG. 4a, Lp1, Lp2, and Lp3 are three primary loops, and Ls1, Ls2, and Ls3 are three secondary loops. When the primary loop Lp1 is charged, the corresponding secondary loop Ls1 is discharged, the primary loops Lp2 and Lp3 are discharged, and the secondary loops Ls2 and Ls3 are charged. Similarly, when the primary loop Lp1 is discharged, the corresponding secondary loop Ls1 is charged, the primary loops Lp2 and Lp3 are charged, and the secondary loops Ls2 and Ls3 are discharged. In this way, the technical effect of completely eliminating electric current ripples may be realized.

In an optional embodiment, still as shown in FIG. 4a, A sequence of switches disposed on the first number of bridge arms the topological structure is

$$[ \begin{matrix}{S}_{11} & {S}_{21} & {S}_{31} \\ {S}_{12} & {S}_{22} & {S}_{32} \\ {S}_{13} & {S}_{23} & {S}_{33}\end{matrix} ] .$$

S₁₁, S₁₂, and S₁₃ are first bridge arm switches, S₂₁, S₂₂, and S₂₃ are second bridge arm switches, and S₃₁, S₃₂, and S₃₃ are third bridge arm switches. S₁₁, S₂₁, and S₃₁ are configured to control a charge state of the number of the primary loops or the number of the secondary loops, S₁₂, S₂₂, and S₃₂ are configured to control the charge state of the number of the primary loops and a discharge state of the number of the secondary loops, and S₁₃, S₂₃, and S₃₃ are configured to control a discharge state of the number of the primary loops or the number of the secondary loops.

As at least one alternative embodiment, when Sᵢⱼ=1(i=1, 2, 3; j=1, 2, 3), the bridge arm switch is in a closed state; and when Sᵢⱼ=0, the bridge arm switch is in a disconnected state. The method includes: if a target phase primary loop is in a charge state, a state of the bridge arm switch connected to the target phase primary loop is

$$[ \begin{matrix}1 \\ 1 \\ 0\end{matrix} ] ,$$

a state of the bridge arm switch connected to a target secondary loop is

$$[ \begin{matrix}0 \\ 1 \\ 1\end{matrix} ] ,$$

and a switch state of another bridge arm is

$$[ \begin{matrix}1 \\ 0 \\ 1\end{matrix} ] .$$

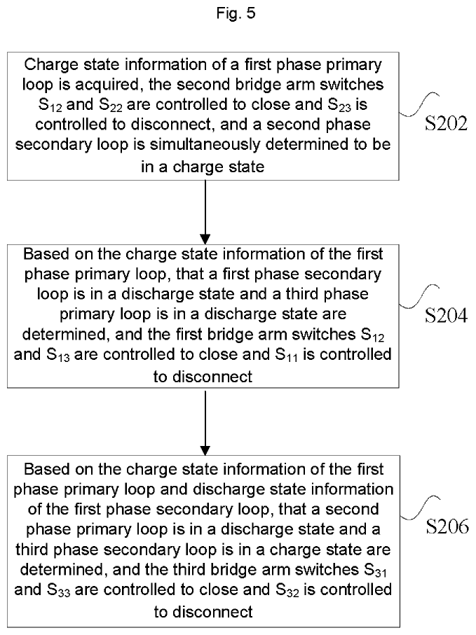

As an optional embodiment, FIG. 5 is a flowchart of an optional method for modulating a switch of a converter according to an embodiment of the present disclosure. As shown in FIG. 5, the method further includes the following steps.

At S202, charge state information of a first phase primary loop is acquired, the second bridge arm switches S₂₁ and S₂₂ are controlled to close and S₂₃ is controlled to disconnect, and a second phase secondary loop is simultaneously determined to be in a charge state.

At S204, based on the charge state information of the first phase primary loop, a first phase secondary loop is in a discharge state, a third phase primary loop is in a discharge state are determined, and the first bridge arm switches S₁₂ and S₁₃ are controlled to close and S₁₁ is controlled to disconnect.

At S206, based on the charge state information of the first phase primary loop and discharge state information of the first phase secondary loop, a second phase primary loop is in a discharge state, a third phase secondary loop is in a charge state are determined, and the third bridge arm switches S₃₁ and S₃₃ are controlled to close and S₃₂ is controlled to disconnect.

As at least one alternative embodiment, the same bridge arm is connected to one primary loop and the secondary loop corresponding to the other primary loop. The charge state or the discharge state of the primary loop and the secondary loop that are connected to the same bridge arm are the same.

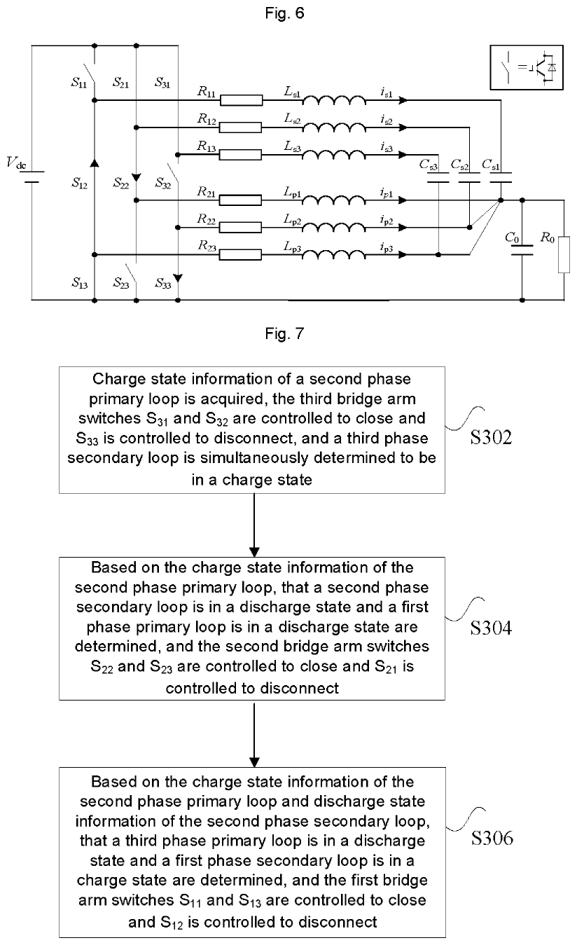

As at least one alternative embodiment, FIG. 6 is a schematic diagram of another optional circuit structure configured to implement the above method for modulating a switch according to an embodiment of the present disclosure. As shown in FIG. 6, when the first phase primary loop Lp1 is charged, the second bridge arm switches S₂₁ and S₂₂ are controlled to close, and S₂₃ is controlled to disconnect. In this case, the switch state of the bridge arm is

$$[ \begin{matrix}{S}_{11} & 1 & {S}_{31} \\ {S}_{12} & 1 & {S}_{32} \\ {S}_{13} & 0 & {S}_{33}\end{matrix} ] .$$

Since the second phase secondary loop Ls2 is connected to the second bridge arm, the second phase secondary loop Ls2 is determined to be in a charge state. Based on a principle that the same phase primary and secondary loops have different charge-discharge states, the first phase secondary loop Ls1 is determined to be in a discharge state, the first bridge arm switches S₁₂ and S₁₃ are controlled to close, and S₁₁ is controlled to disconnect. In this case, the switch state of the bridge arm is

$$[ \begin{matrix}0 & 1 & {S}_{31} \\ 1 & 1 & {S}_{32} \\ 1 & 0 & {S}_{33}\end{matrix} ] ,$$

and the third phase primary loop Lp3 connected to the first bridge arm is determined to be in a discharge state. Likewise, based on the principle that the same phase primary and secondary loops have different charge-discharge states, that the second phase primary loop Lp2 is in a discharge state and the third phase secondary loop Ls3 is in a charge state are determined, the third bridge arm switches S₃₁ and S₃₃ are controlled to close, and S₃₂ is controlled to disconnect. In this case, the switch state of the bridge arm is

$$[ \begin{matrix}0 & 1 & 1 \\ 1 & 1 & 0 \\ 1 & 0 & 1\end{matrix} ] .$$

As an optional embodiment, FIG. 7 is a flowchart of another method for modulating a switch of a converter according to an embodiment of the present disclosure. As shown in FIG. 7, the method further includes the following steps.

At S302, charge state information of a second phase primary loop is acquired, the third bridge arm switches S₃₁ and S₃₂ are controlled to close and S₃₃ is controlled to disconnect, and a third phase secondary loop is simultaneously determined to be in a charge state.

At S304, based on the charge state information of the second phase primary loop, a second phase secondary loop is in a discharge state and a first phase primary loop is in a discharge state are determined, and the second bridge arm switches S₂₂ and S₂₃ are controlled to close and S₂₁ is controlled to disconnect.

At S306, based on the charge state information of the second phase primary loop and discharge state information of the second phase secondary loop, a third phase primary loop is in a discharge state, a first phase secondary loop is in a charge state are determined, and the first bridge arm switches S₁₁ and S₁₃ are controlled to close and S₁₂ is controlled to disconnect.

As at least one alternative embodiment, the same bridge arm is connected to one primary loop and the secondary loop corresponding to the other primary loop. The charge state or the discharge state of the primary loop and the secondary loop that are connected to the same bridge arm are the same.

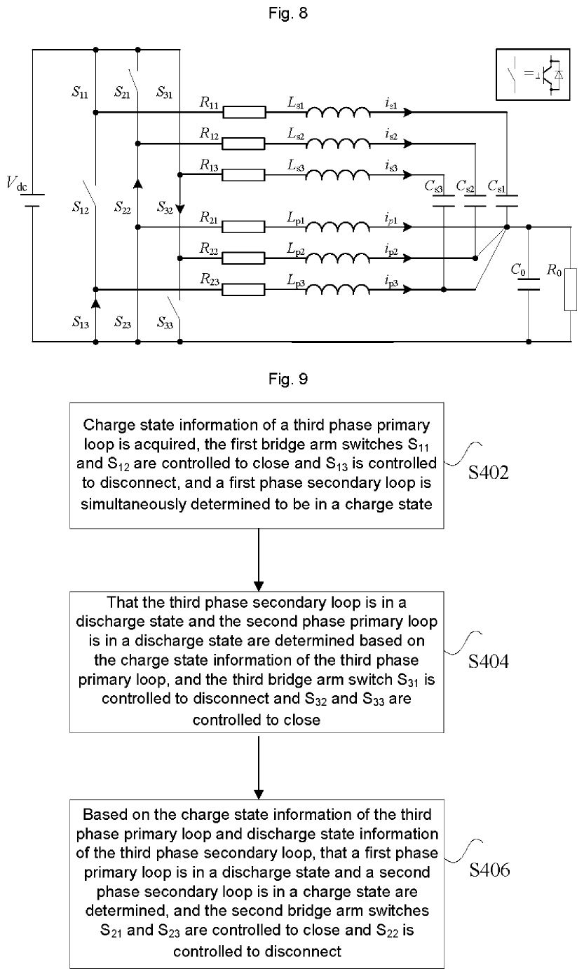

As at least one alternative embodiment, FIG. 8 is a schematic diagram of another optional circuit structure configured to implement the above method for modulating a switch according to an embodiment of the present disclosure. As shown in FIG. 8, when the second phase primary loop Lp2 is charged, the third bridge arm switches S₃₁ and S₃₂ are controlled to close, and S₃₃ is controlled to disconnect. In this case, the switch state of the bridge arm is

$$[ \begin{matrix}{S}_{11} & {S}_{21} & 1 \\ {S}_{12} & {S}_{22} & 1 \\ {S}_{13} & {S}_{23} & 0\end{matrix} ] .$$

Since the third phase secondary loop Ls3 is connected to the third bridge arm, the third phase secondary loop Ls3 is determined to be in a charge state. Based on the principle that the same phase primary and secondary loops have different charge-discharge states, the second phase secondary loop Ls2 is determined to be in a discharge state, the second bridge arm switches S₂₂ and S₂₃ are controlled to close, and S₂₁ is controlled to disconnect. In this case, the switch state of the bridge arm is

$$[ \begin{matrix}{S}_{11} & 0 & 1 \\ {S}_{12} & 1 & 1 \\ {S}_{13} & 1 & 0\end{matrix} ] ,$$

and the first phase primary loop Lp1 is simultaneously determined to be in a discharge state. Likewise, based on the principle that the same phase primary and secondary loops have different charge-discharge states, that the third phase primary loop Lp3 is in a discharge state and the first phase secondary loop Ls1 is in a charge state are determined, the first bridge arm switches S₁₁ and S₁₃ are controlled to close, and S₁₂ is controlled to disconnect. In this case, the switch state of the bridge arm is

$$[ \begin{matrix}1 & 0 & 1 \\ 0 & 1 & 1 \\ 1 & 1 & 0\end{matrix} ] .$$

As an optional embodiment, FIG. 9 is a flowchart of another optional method for modulating a switch of a converter according to an embodiment of the present disclosure. As shown in FIG. 9, the method further includes the following steps.

At S402, charge state information of a third phase primary loop is acquired, the first bridge arm switches S₁₁ and S₁₂ are controlled to close and S₁₃ is controlled to disconnect, and a first phase secondary loop is simultaneously determined to be in a charge state.

At S404, the third phase secondary loop is in a discharge state and the second phase primary loop is in a discharge state are determined based on the charge state information of the third phase primary loop, and the third bridge arm switch S₃₁ is controlled to disconnect and S₃₂ and S₃₃ are controlled to close.

At S406, based on the charge state information of the third phase primary loop and discharge state information of the third phase secondary loop, a first phase primary loop is in a discharge state and a second phase secondary loop is in a charge state are determined, and the second bridge arm switches S₂₁ and S₂₃ are controlled to close and S₂₂ is controlled to disconnect.

As at least one alternative embodiment, the same bridge arm is connected to one primary loop and the secondary loop corresponding to the other primary loop. The charge state or the discharge state of the primary loop and the secondary loop that are connected to the same bridge arm are the same.

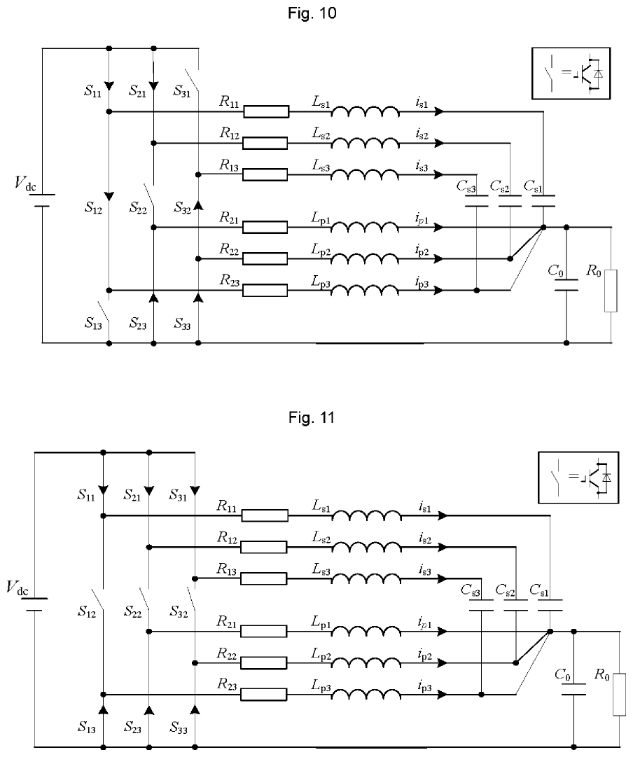

As at least one alternative embodiment, FIG. 10 is a schematic diagram of another optional circuit structure configured to implement the above method for modulating a switch according to an embodiment of the present disclosure. As shown in FIG. 10, when the third phase primary loop Lp3 is charged, the first bridge arm switches S₁₁ and S₁₂ are controlled to close, and S₁₃ is controlled to disconnect. In this case, the switch state of the bridge arm is

$$[ \begin{matrix}1 & {S}_{21} & {S}_{13} \\ 1 & {S}_{22} & {S}_{23} \\ 0 & {S}_{23} & {S}_{33}\end{matrix} ] .$$

Since the first phase secondary loop Ls1 is connected to the first bridge arm, the first phase secondary loop Ls1 is determined to be in a charge state. Based on the principle that the same phase primary and secondary loops have different charge-discharge states, the third phase secondary loop Ls3 is determined to be in a discharge state, the third bridge arm switch S₁₃ is controlled to disconnect, and S₃₂ and S₃₃ are controlled to close. In this case, the switch state of the bridge arm is

$$[ \begin{matrix}1 & {S}_{12} & 0 \\ 1 & {S}_{22} & 1 \\ 0 & {S}_{32} & 1\end{matrix} ] ,$$

and the second phase primary loop Lp2 is simultaneously determined to be in a discharge state. Likewise, based on the principle that the same phase primary and secondary loops have different charge-discharge states, that the first phase primary loop Lp1 is in a discharge state and the second phase secondary loop Ls2 is in a charge state are determined, the second bridge arm switches S₂₁ and S₂₃ are controlled to close, and S₂₂ is controlled to disconnect. In this case, the switch state of the bridge arm is

$$[ \begin{matrix}1 & 1 & 0 \\ 1 & 0 & 1 \\ 0 & 1 & 1\end{matrix} ] .$$

In an optional embodiment, that the first phase secondary loop, the second phase secondary loop, and the third phase secondary loop are all in a charge state is determined if the first phase primary loop, the second phase primary loop, and the third phase primary loop are all in a discharge state. The first bridge arm switches S₁₁ and S₁₃ are controlled to close and S₁₂ is controlled to disconnect. The second bridge arm switches S₂₁ and S₂₃ are controlled to close and S₂₂ is controlled to disconnect. The third bridge arm switches S₃₁ and S₃₃ are controlled to close and S₃₂ is controlled to disconnect.

As at least one alternative embodiment, FIG. 11 is a schematic diagram of another optional circuit structure configured to implement the above method for modulating a switch according to an embodiment of the present disclosure. As shown in FIG. 11, if the first phase primary loop, the second phase primary loop, and the third phase primary loop (that is, Lp1, Lp2, and Lp3) are all in a discharge state, and based on the principle that the same phase primary and secondary loops have different charge-discharge states, the first phase secondary loop, the second phase secondary loop, and the third phase secondary loop (that is, Ls1, Ls2, and Ls3) are all determined to be in a charge state. The first bridge arm switches S₁₁ and S₁₃ are controlled to close and S₁₂ is controlled to disconnect. The second bridge arm switches S₂₁ and S₂₃ are controlled to close and S₂₂ is controlled to disconnect. The third bridge arm switches S₃₁ and S₃₃ are controlled to close and S₃₂ is controlled to disconnect. In this case, the switch state of the bridge arm is

$$[ \begin{matrix}1 & 1 & 1 \\ 0 & 0 & 0 \\ 1 & 1 & 1\end{matrix} ] .$$

In an optional embodiment, the method is applicable to a topological structure of a two-phase stacked interleaved buck converter. A switch sequence of bridge arm switches of the topological structure is

$$[ \begin{matrix}{S}_{11} & {S}_{21} \\ {S}_{12} & {S}_{22} \\ {S}_{13} & {S}_{23}\end{matrix} ] .$$

S₁₁, S₁₂, and S₁₃ are first bridge arm switches, and S₂₁, S₂₂, and S₂₃ are second bridge arm switches. S₁₁ and S₂₁ are configured to control a charge state of the number of the primary loops or the number of the secondary loops, S₁₂ and S₂₂ are configured to control the charge state of the number of the primary loops and a discharge state of the number of the secondary loops, and S₁₃ and S₂₃ are configured to control a discharge state of the number of the primary loops or the number of the secondary loops.

As at least one alternative embodiment, when Sᵢⱼ=1(i=1, 2; j=1, 2, 3), the bridge arm switch is in a closed state; and when Sᵢⱼ=0, the bridge arm switch is in a disconnected state. The method includes: if a target phase primary loop is in a charge state, a state of the bridge arm switch connected to the target phase primary loop is

$$[ \begin{matrix}1 \\ 1 \\ 0\end{matrix} ] ,$$

a state of the bridge arm switch connected to a target secondary loop is

$$[ \begin{matrix}0 \\ 1 \\ 1\end{matrix} ] ,$$

and a switch state of another bridge arm is

$$[ \begin{matrix}1 \\ 0 \\ 1\end{matrix} ] .$$

In an optional embodiment, the method further includes the following steps.

At S502, charge state information of a first phase primary loop is acquired, the second bridge arm switches S₂₁ and S₂₂ are controlled to close and S₂₃ is controlled to disconnect, and a second phase secondary loop is simultaneously determined to be in a charge state.

At S504, that the first phase secondary loop is in a discharge state and the second phase primary loop is in a discharge state are determined based on the charge state information of the first phase primary loop, and the first bridge arm switch S₁₁ is controlled to disconnect, and S₁₂ and S₁₃ are controlled to close.

As at least one alternative embodiment, the same bridge arm is connected to one primary loop and the secondary loop corresponding to the other primary loop. The charge state or the discharge state of the primary loop and the secondary loop that are connected to the same bridge arm are the same.

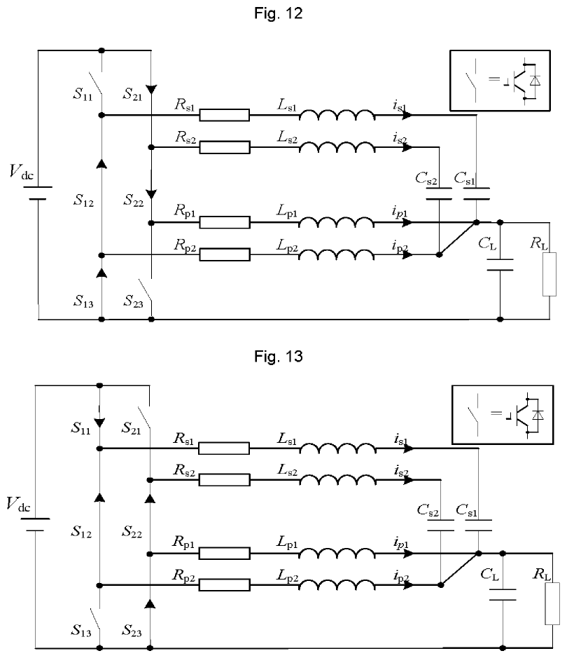

As at least one alternative embodiment, FIG. 12 is a schematic diagram of an optional circuit structure configured to implement the above method for modulating a switch according to an embodiment of the present disclosure. As shown in FIG. 12, when the first phase primary loop Lp1 is charged, the second bridge arm switches S₂₁ and S₂₂ are controlled to close, and S₂₃ is controlled to disconnect. In this case, the switch state of the bridge arm is

$$[ \begin{matrix}{S}_{11} & 1 \\ {S}_{12} & 1 \\ {S}_{13} & 0\end{matrix} ] .$$

Since the second phase secondary loop Ls2 is connected to the second bridge arm, the second phase secondary loop Ls2 is determined to be in a charge state. Based on the principle that the same phase primary and secondary loops have different charge-discharge states, the first phase secondary loop Ls1 is determined to be in a discharge state, the first bridge arm switch S₁₁ is controlled to disconnect, and S₁₂ and S₁₃ are controlled to close. In this case, the switch state of the bridge arm is

$$[ \begin{matrix}0 & 1 \\ 1 & 1 \\ 1 & 0\end{matrix} ] ,$$

and the second phase primary loop Lp2 is simultaneously determined to be in a charge state.

In an optional embodiment, the method further includes the following steps.

At S602, the charge state information of the second phase primary loop is acquired, the first bridge arm switches S₁₁ and S₁₂ are controlled to close and S₁₃ is controlled to disconnect, and the first phase secondary loop is simultaneously determined to be in a charge state.

At S604, based on the charge state information of the second phase primary loop, the second phase secondary loop is in a discharge state and the first phase primary loop is in a discharge state are determined, and the second bridge arm switches S₂₂ and S₂₃ are controlled to close and S₂₁ is controlled to disconnect.

As at least one alternative embodiment, the same bridge arm is connected to one primary loop and the secondary loop corresponding to the other primary loop. The charge state or the discharge state of the primary loop and the secondary loop that are connected to the same bridge arm are the same.

As at least one alternative embodiment, FIG. 13 is a schematic diagram of an optional circuit structure configured to implement the above method for modulating a switch according to an embodiment of the present disclosure. As shown in FIG. 13, when the second phase primary loop Lp2 is charged, the first bridge arm switches S₁₁ and S₁₂ are controlled to close, and S₁₃ is controlled to disconnect. In this case, the switch state of the bridge arm is

$$[ \begin{matrix}1 & {S}_{21} \\ 1 & {S}_{22} \\ 0 & {S}_{23}\end{matrix} ] .$$

Since the first phase secondary loop Ls1 is connected to the first bridge arm, the first phase secondary loop Ls1 is determined to be in a charge state. Based on the principle that the same phase primary and secondary loops have different charge-discharge states, the second phase secondary loop Ls2 is determined to be in a discharge state, the second bridge arm switches S₂₂ and S₂₃ are controlled to close, and S₂₁ is controlled to disconnect. In this case, the switch state of the bridge arm is

$$[ \begin{matrix}1 & 0 \\ 1 & 1 \\ 0 & 1\end{matrix} ] ,$$

and the first phase primary loop Lp1 is simultaneously determined to be in a charge state.

In an optional embodiment, that both the first phase secondary loop and the second phase secondary loop are in a charge state are determined if both the first phase primary loop and the second phase primary loop are in a discharge state; the first bridge arm switches S₁₁ and S₁₃ are controlled to close and S₁₂ is controlled to disconnect; and the second bridge arm switches S₂₁ and S₂₃ are controlled to close and S₂₂ is controlled to disconnect.

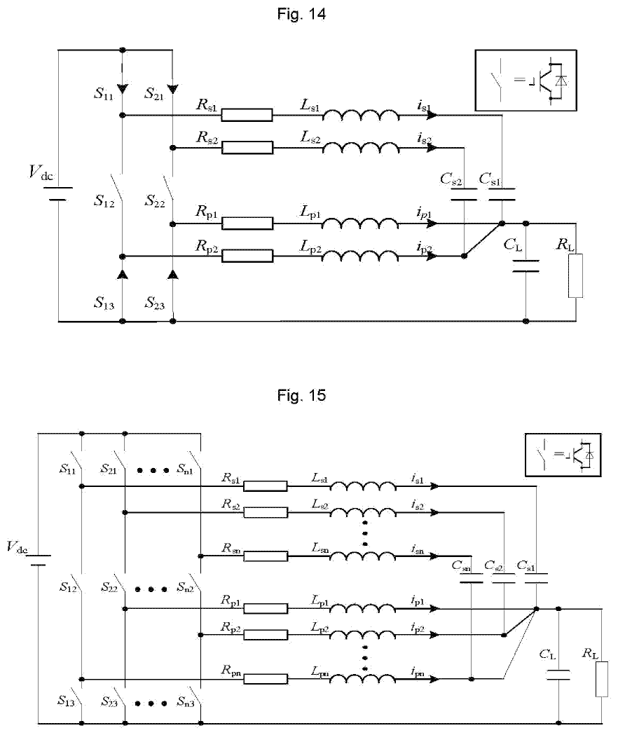

As at least one alternative embodiment, FIG. 14 is a schematic diagram of another optional circuit structure configured to implement the above method for modulating a switch according to an embodiment of the present disclosure. As shown in FIG. 14, if both the first phase primary loop and the second phase primary loop (that is, Lp1 and Lp2) are in a discharge state, and based on the principle that the same phase primary and secondary loops have different charge-discharge states, both the first phase secondary loop and the second phase secondary loop (that is, Ls1 and Ls2) are determined to be in a charge state. The first bridge arm switches S₁₁ and S₁₃ are controlled to close, and S₁₂ is controlled to disconnect. The second bridge arm switches S₂₁ and S₂₃ are controlled to close, and S₂₂ is controlled to disconnect. In this case, the switch state of the bridge arm is

$$[ \begin{matrix}1 & 1 \\ 0 & 0 \\ 1 & 1\end{matrix} ] .$$

### Embodiment 2

An embodiment of the present disclosure provides a topological structure of a multiphase stacked interleaved buck converter. FIG. 15 is a schematic diagram of a topological structure of a multiphase stacked interleaved buck converter according to an embodiment of the present disclosure. As shown in FIG. 15, the topological structure includes a first number of primary loops, a first number of secondary loops, and a first number of bridge arms.

The first number of secondary loops are connected to the first number of primary loops and configured to eliminate electric current ripples in the loops.

The first number of bridge arms are connected to the first number of primary loops and the first number of secondary loops, and configured to control charge-discharge states of the first number of primary loops and the first number of secondary loops.

In this embodiment of the present disclosure, a manner of constructing the topological structure of the multiphase stacked interleaved buck converter is adopted. The first number of primary loops are disposed. The first number of secondary loops are connected to the first number of primary loops and configured to eliminate the electric current ripples in the loops. The first number of bridge arms are connected to the first number of primary loops and the first number of secondary loops, and configured to control charge-discharge states of the first number of primary loops and the first number of secondary loops. In this way, a purpose of optimizing the interleaved buck converter is achieved. Therefore, the technical effects of reducing the excessive large current stress of the switches in the interleaved buck converter and enhancing the operation efficiency of the interleaved buck converter can be realized, thereby resolving the technical problems of excessive large current stress of the switches in the interleaved buck converter and low operation efficiency and fault tolerance of the interleaved buck converter in the related art.

As at least one alternative embodiment, the number of the primary loops, secondary loops, and bridge arms in the topological structure of the multiphase stacked interleaved buck converter are the same.

As at least one alternative embodiment, the topological structure of the multiphase stacked interleaved buck converter may be, but is not limited to, applicable to a buck circuit, a boost circuit, and a z-source conversion circuit.

As at least one alternative embodiment, in the topological structure of the multiphase stacked interleaved buck converter still as shown in FIG. 15, the first number of primary loops are connected in parallel and configured to reduce an average current flowing through the inductor. Since a plurality of primary loops are connected in parallel, a total output current is shunted, so that large current output may be achieved, the average current flowing through the inductor may be reduced, and current stress flowing through the switches may also be reduced. In addition, the fault tolerance of a circuit is improved. When some bridge arm fails, other bridge arms may continue to operate, thereby enhancing the efficiency of the entire converter.

In an optional embodiment, the first number of bridge arms include: a second number of bridge arm switches, configured to control the charge-discharge states of the first number of primary loops and the first number of secondary loops based on switch states of the bridge arm switches.

As at least one alternative embodiment, in the topological structure of the multiphase stacked interleaved buck converter still as shown in FIG. 15, the topological structure includes n primary loops, n secondary loops, and n bridge arms. Each bridge arm is provided with three bridge arm switches. By adjusting the bridge arm switches on each bridge arm, the charge-discharge states of the primary loops and the secondary loops may be controlled.

In an optional embodiment, the first number of bridge arms include the following. The number of bridge arm switches on each bridge arm is same, and time periods that different bridge arm switches disposed on each bridge arm are in an off state are different. The same bridge arm is connected to one primary loop and the secondary loop corresponding to the other primary loop.

As at least one alternative embodiment, the number of the bridge arm switches on each bridge arm is the same. For example, in a schematic diagram of the topological structure of the multiphase stacked interleaved buck converter shown in FIG. 15, each bridge arm is provided with three bridge arm switches, and the three bridge arm switches mounted on the same bridge arm cannot be in an off state at the same time. S₁₁, S₂₁, and S₃₁ are three bridge arm switches on the first bridge arm, S₁₂, S₂₂, and S₃₂ are three bridge arm switches on the second bridge arm, . . . , S1n, S2n, and S3n are three bridge arm switches on the nth bridge arm.

In an optional embodiment, each primary loop includes at least an inductor. The inductor and a load are serially connected to the primary loop. Each secondary loop includes at least the inductor and a capacitor. The inductor and the capacitor are serially connected to the secondary loop.

As at least one alternative embodiment, the topological structure of the multiphase stacked interleaved buck converter still as shown in FIG. 15 is provided with n primary loops and n secondary loops. Each primary loop is provided with a resistor and an inductor. (Rₚ₁, Lₚ₁) in FIG. 15 is the first primary loop, (Rₚ₂, Lₚ₂) is the second primary loop, . . . , (Rₚₙ, Lₚₙ) is the nth primary loop. Each secondary loop is provided with an inductor and a capacitor. (Rₛ₁, Lₛ₁, Cₛ₁) in FIG. 15 is the first secondary loop, (Rₛ₂, Lₛ₂, Cₛ₂) is the second secondary loop, . . . , (Rₛₙ, Lₛₙ, Cₛₙ) is the nth secondary loop.

As at least one alternative embodiment, the electric current ripple is further configured to determine an inductance parameter of the inductor within a target time period. An equation of the electric current ripple within the target time period is

$$Δ i = \frac{D ( 1 - D )}{fL} {V}_{IN} .$$

Δi is the electric current ripple, D is a duty cycle of the multiphase stacked interleaved buck converter, f is a switching frequency of a switch of the multiphase stacked interleaved buck converter, L is the inductor, and V_{IN} is an input voltage of the multiphase stacked interleaved buck converter. The target time period may be, but is not limited to, a certain time period within a cycle.

It is to be noted that, according to the multiphase stacked interleaved topological structure, the output electric current ripple may be completely canceled within a certain duty cycle range. In addition, since there are a plurality of primary loops, the function of shunting may be realized, and the current flowing through the inductor is one nth of a load current (n is the number of phases), so that the current stress flowing through each switch is also reduced. Therefore, large current may be outputted, and the efficiency of the converter may be obviously enhanced. Through the adoption of multiphase stacking and interleaving, better fault tolerance may be realized. When one bridge arm fails, other bridge arms may continue to operate, thereby achieving the technical effect of enhancing the operation efficiency of the converter.

### Embodiment 3

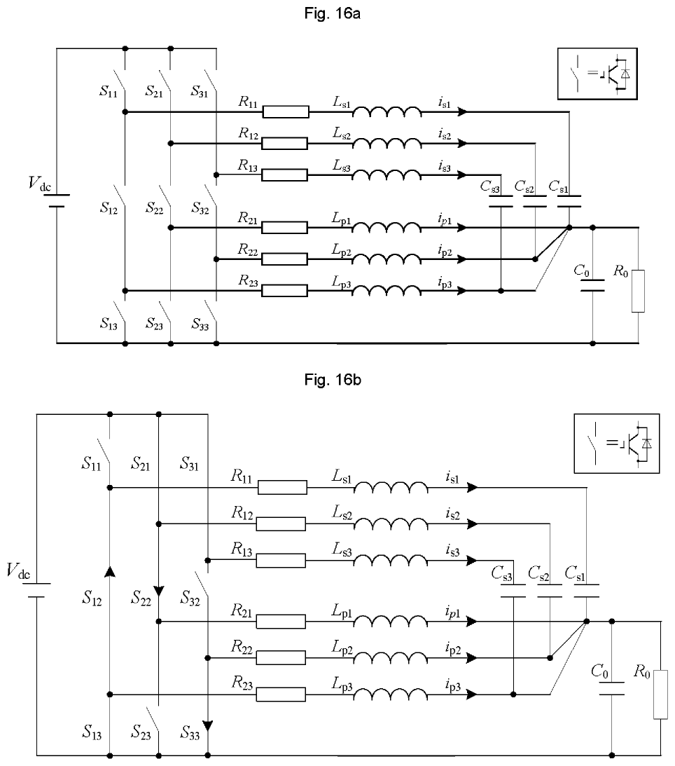

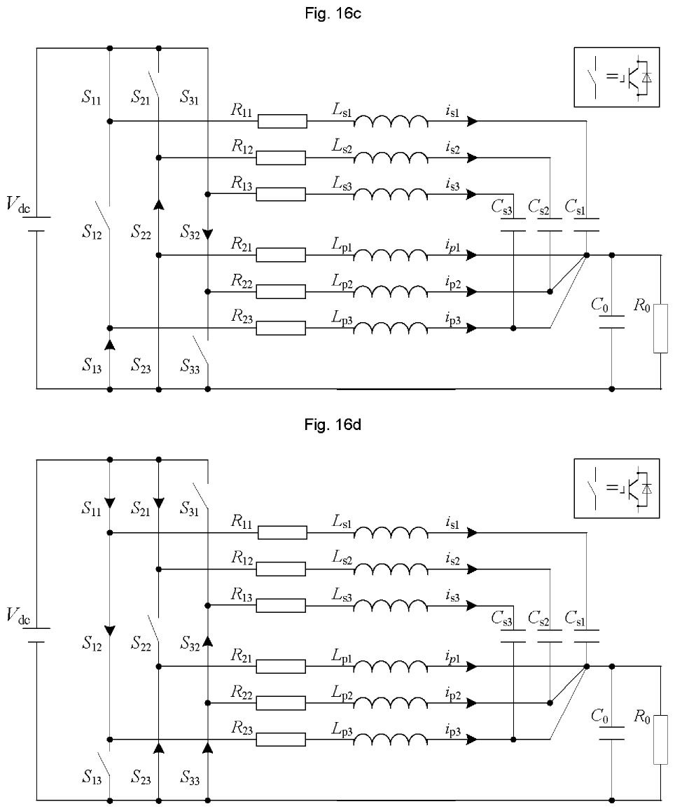

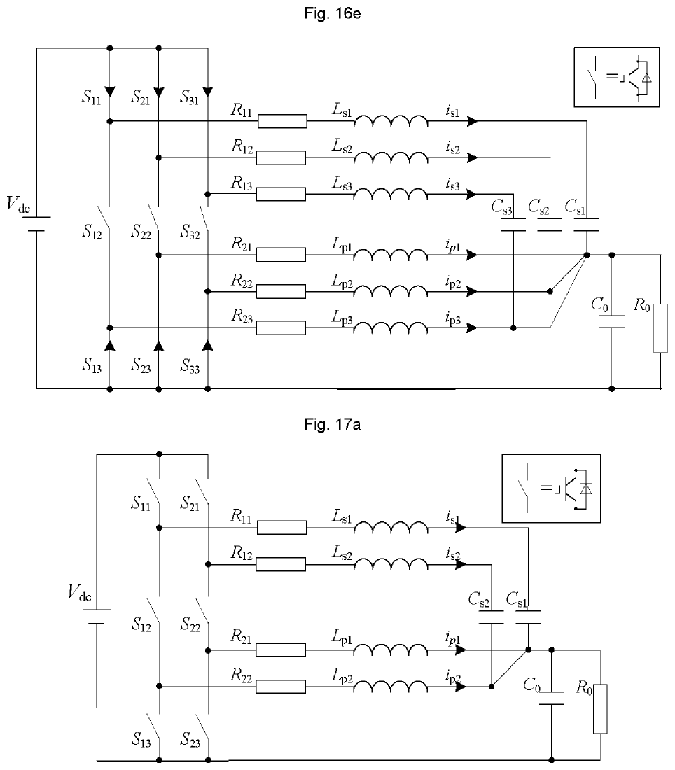

An embodiment of the present disclosure provides a topological structure of a three-phase stacked interleaved buck converter. FIG. 16a is a schematic diagram of a topological structure of an optional three-phase stacked interleaved buck converter according to an embodiment of the present disclosure. As shown in FIG. 16a, the topological structure includes three primary loops, three secondary loops, and three bridge arms.

The three secondary loops are connected to the three primary loops and configured to eliminate electric current ripples in the loops.

The three bridge arms are connected to the three primary loops and the three secondary loops, and configured to control charge-discharge states of the three primary loops and the three secondary loops.

In this embodiment of the present disclosure, a manner of constructing the topological structure of the multiphase stacked interleaved buck converter is adopted. Three primary loops are disposed. The three secondary loops are connected to the three primary loops and configured to eliminate the electric current ripples in the loops. The three bridge arms are connected to the three primary loops and the three secondary loops, and configured to control charge-discharge states of the three primary loops and the three secondary loops. In this way, a purpose of optimizing the topological structure of the interleaved buck converter is achieved. Therefore, the technical effects of reducing the excessive large current stress of the switches in the interleaved buck converter and enhancing the operation efficiency of the interleaved buck converter can be realized, thereby resolving the technical problems of excessive large current stress of the switches in the interleaved buck converter and low operation efficiency and fault tolerance of the interleaved buck converter in the related art.

As at least one alternative embodiment, the topological structure of the three-phase stacked interleaved buck converter may be, but is not limited to, applicable to a buck circuit, a boost circuit, and a z-source conversion circuit.

As at least one alternative embodiment, in the topological structure of the three-phase stacked interleaved buck converter still as shown in FIG. 16a, Lp1, Lp2, and Lp3 are three primary loops, and Ls1, Ls2, and Ls3 are three secondary loops. S₁₁, S₁₂, and S₁₃ correspond to the first bridge arm; S₂₁, S₂₂, and S₂₃ correspond to the second bridge arm; and S₃₁, S₃₂, and S₃₃ correspond to the third bridge arm. The three primary loops are connected in parallel and configured to reduce an average current flowing through the inductor. Since the three primary loops Lp1, Lp2, and Lp3 are connected in parallel, a total output current is shunted, so that large current output may be achieved, the average current flowing through the inductor may be reduced, and current stress flowing through the switches may also be reduced. In addition, the fault tolerance of a circuit is improved. When some bridge arm fails, other bridge arms may continue to operate, thereby enhancing the efficiency of the entire converter.

In an optional embodiment, each of the three bridge arms includes: three bridge arm switches, configured to control the charge-discharge states of the three primary loops and the three secondary loops based on switch states of the bridge arm switches. The three bridge arm switches cannot be in an off state at the same time.

As at least one alternative embodiment, the number of bridge arm switches on each of the three bridge arms is the same, and time periods that different bridge arm switches disposed on each bridge arm are in an off state are different. The same bridge arm is connected to one primary loop and the secondary loop corresponding to the other primary loop.

As at least one alternative embodiment, in the topological structure of the three-phase stacked interleaved buck converter still as shown in FIG. 16a, a sequence of switches disposed on the first number of bridge arms the topological structure is

$$[ \begin{matrix}{S}_{11} & {S}_{21} & {S}_{31} \\ {S}_{12} & {S}_{22} & {S}_{32} \\ {S}_{13} & {S}_{23} & {S}_{33}\end{matrix} ] .$$

S₁₁, S₁₂, and S₁₃ are first bridge arm switches, S₂₁, S₂₂, and S₂₃ are second bridge arm switches, and S₃₁, S₃₂, and S₃₃ are third bridge arm switches. S₁₁, S₂₁, and S₃₁ are configured to control a charge state of the number of the primary loops or the number of the secondary loops, S₁₂, S₂₂, and S₃₂ are configured to control the charge state of the number of the primary loops and a discharge state of the number of the secondary loops, and S₁₃, S₂₃, and S₃₃ are configured to control a discharge state of the number of the primary loops or the number of the secondary loops.

As at least one alternative embodiment, when Sᵢⱼ=1(i=1, 2, 3; j=1, 2, 3), the bridge arm switch is in a closed state; and when Sᵢⱼ=0, the bridge arm switch is in a disconnected state. The method includes: if a target phase primary loop is in a charge state, a state of the bridge arm switch connected to the target phase primary loop is

$$[ \begin{matrix}1 \\ 1 \\ 0\end{matrix} ] ,$$

a state of the bridge arm switch connected to a target secondary loop is

$$[ \begin{matrix}0 \\ 1 \\ 1\end{matrix} ] ,$$

and a switch state of another bridge arm is

$$[ \begin{matrix}1 \\ 0 \\ 1\end{matrix} ] .$$

As an optional embodiment, FIG. 16b is a schematic diagram of a topological structure of another optional three-phase stacked interleaved buck converter according to an embodiment of the present disclosure. As shown in FIG. 16b, when the first phase primary loop Lp1 is charged, the second bridge arm switches S₂₁ and S₂₂ are controlled to close, and S₂₃ is controlled to disconnect. In this case, the switch state of the bridge arm is

$$[ \begin{matrix}{S}_{11} & 1 & {S}_{31} \\ {S}_{12} & 1 & {S}_{32} \\ {S}_{13} & 0 & {S}_{33}\end{matrix} ] .$$

Since the second phase secondary loop Ls2 is connected to the second bridge arm, the second phase secondary loop Ls2 is determined to be in a charge state. Based on a principle that the same phase primary and secondary loops have different charge-discharge states, the first phase secondary loop Ls1 is determined to be in a discharge state, the first bridge arm switches S₁₂ and S₁₃ are controlled to close, and S₁₁ is controlled to disconnect. In this case, the switch state of the bridge arm is

$$[ \begin{matrix}0 & 1 & {S}_{31} \\ 1 & 1 & {S}_{32} \\ 1 & 0 & {S}_{33}\end{matrix} ] ,$$

and the third phase primary loop Lp3 connected to the first bridge arm is determined to be in a discharge state. Likewise, based on the principle that the same phase primary and secondary loops have different charge-discharge states, that the second phase primary loop Lp2 is in a discharge state and the third phase secondary loop Ls3 is in a charge state are determined, the third bridge arm switches S₃₁ and S₃₃ are controlled to close, and S₃₂ is controlled to disconnect. In this case, the switch state of the bridge arm is

$$[ \begin{matrix}0 & 1 & 1 \\ 1 & 1 & 0 \\ 1 & 0 & 1\end{matrix} ] .$$

As an optional embodiment, FIG. 16c is a schematic diagram of a topological structure of another optional three-phase stacked interleaved buck converter according to an embodiment of the present disclosure. As shown in FIG. 16c, when the second phase primary loop Lp2 is charged, the third bridge arm switches S₃₁ and S₃₂ are controlled to close, and S₃₃ is controlled to disconnect. In this case, the switch state of the bridge arm is

$$[ \begin{matrix}{S}_{11} & {S}_{21} & 1 \\ {S}_{12} & {S}_{22} & 1 \\ {S}_{13} & {S}_{23} & 0\end{matrix} ] .$$

Since the third phase secondary loop Ls3 is connected to the third bridge arm, the third phase secondary loop Ls3 is determined to be in a charge state. Based on the principle that the same phase primary and secondary loops have different charge-discharge states, the second phase secondary loop Ls2 is determined to be in a discharge state, the second bridge arm switches S₂₂ and S₂₃ are controlled to close, and S₂₁ is controlled to disconnect. In this case, the switch state of the bridge arm is

$$[ \begin{matrix}{S}_{11} & 0 & 1 \\ {S}_{12} & 1 & 1 \\ {S}_{13} & 1 & 0\end{matrix} ] ,$$

and the first phase primary loop Lp1 is simultaneously determined to be in a discharge state. Likewise, based on the principle that the same phase primary and secondary loops have different charge-discharge states, that the third phase primary loop Lp3 is in a discharge state and the first phase secondary loop Ls1 is in a charge state are determined, the first bridge arm switches S₁₁ and S₁₃ are controlled to close, and S₁₂ is controlled to disconnect. In this case, the switch state of the bridge arm is

$$[ \begin{matrix}1 & 0 & 1 \\ 0 & 1 & 1 \\ 1 & 1 & 0\end{matrix} ] .$$

As an optional embodiment, FIG. 16d is a schematic diagram of a topological structure of another optional three-phase stacked interleaved buck converter according to an embodiment of the present disclosure. As shown in FIG. 16d, when the third phase primary loop Lp3 is charged, the first bridge arm switches S₁₁ and S₁₂ are controlled to close, and S₁₃ is controlled to disconnect. In this case, the switch state of the bridge arm is

$$[ \begin{matrix}1 & {S}_{21} & {S}_{31} \\ 1 & {S}_{22} & {S}_{32} \\ 0 & {S}_{23} & {S}_{33}\end{matrix} ] .$$

Since the first phase secondary loop Ls1 is connected to the first bridge arm, the first phase secondary loop Ls1 is determined to be in a charge state. Based on the principle that the same phase primary and secondary loops have different charge-discharge states, the third phase secondary loop Ls3 is determined to be in a discharge state, the third bridge arm switch S₃₁ is controlled to disconnect, and S₃₂ and S₃₃ are controlled to close. In this case, the switch state of the bridge arm is

$$[ \begin{matrix}1 & {S}_{21} & 0 \\ 1 & {S}_{22} & 1 \\ 0 & {S}_{23} & 1\end{matrix} ] ,$$

and the second phase primary loop Lp2 is simultaneously determined to be in a discharge state. Likewise, based on the principle that the same phase primary and secondary loops have different charge-discharge states, that the first phase primary loop Lp1 is in a discharge state and the second phase secondary loop Ls2 is in a charge state are determined, the second bridge arm switches S₂₁ and S₂₃ are controlled to close, and S₂₂ is controlled to disconnect. In this case, the switch state of the bridge arm is

$$[ \begin{matrix}1 & 1 & 0 \\ 1 & 0 & 1 \\ 0 & 1 & 1\end{matrix} ] .$$

As an optional embodiment, FIG. 16e is a schematic diagram of a topological structure of another optional three-phase stacked interleaved buck converter according to an embodiment of the present disclosure. As shown in FIG. 16e, if the first phase primary loop, the second phase primary loop, and the third phase primary loop (that is, Lp1, Lp2, and Lp3) are all in a discharge state, and based on the principle that the same phase primary and secondary loops have different charge-discharge states, the first phase secondary loop, the second phase secondary loop, and the third phase secondary loop (that is, Ls1, Ls2, and Ls3) are all determined to be in a charge state. The first bridge arm switches S₁₁ and S₁₃ are controlled to close and S₂₁ is controlled to disconnect. The second bridge arm switches S₂₁ and S₂₃ are controlled to close and S₂₂ is controlled to disconnect. The third bridge arm switches S₃₁ and S₃₃ are controlled to close and S₂₃ is controlled to disconnect. In this case, the switch state of the bridge arm is

$$[ \begin{matrix}1 & 1 & 1 \\ 0 & 0 & 0 \\ 1 & 1 & 1\end{matrix} ] .$$

It is to be noted that, according to the three-phase stacked interleaved topological structure, the output electric current ripple may be completely canceled within a certain duty cycle range. In addition, since there are three primary loops, the function of shunting may be realized, and the current flowing through the inductor is one third of the load current, so that the current stress flowing through each switch is also reduced. Therefore, large current may be outputted, and the efficiency of the converter may be obviously enhanced. Through the adoption of three-phase stacking and interleaving, better fault tolerance may be realized. When one bridge arm fails, other bridge arms may continue to operate, thereby achieving the technical effect of enhancing the operation efficiency of the buck converter.

### Embodiment 4

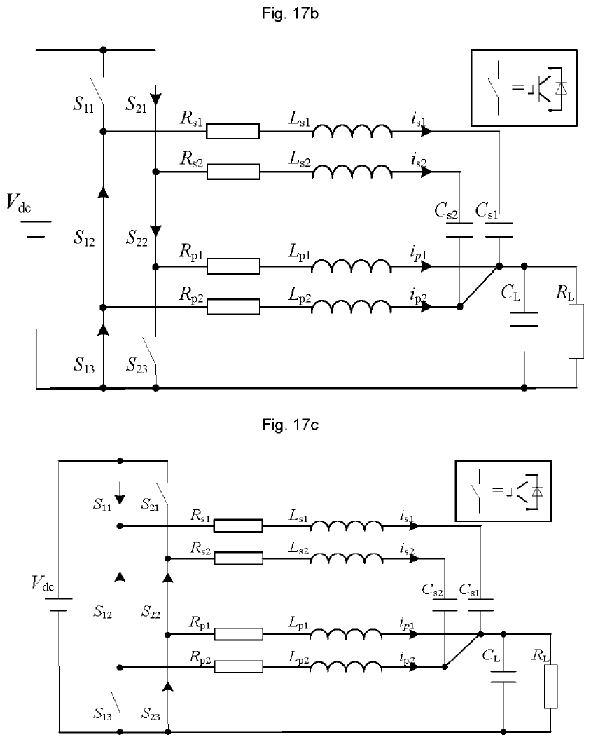

An embodiment of the present disclosure provides a topological structure of a two-phase stacked interleaved buck converter. FIG. 17a is a schematic diagram of a topological structure of an optional two-phase stacked interleaved buck converter according to an embodiment of the present disclosure. As shown in FIG. 17a, the topological structure includes two primary loops, two secondary loops, and two bridge arms.

The two secondary loops are connected to the two primary loops and configured to eliminate electric current ripples in the loops.

The two bridge arms are connected to the two primary loops and the two secondary loops, and configured to control charge-discharge states of the two primary loops and the two secondary loops.

In this embodiment of the present disclosure, a manner of constructing the topological structure of the multiphase stacked interleaved buck converter is adopted. Two primary loops are disposed. The two secondary loops are connected to the two primary loops and configured to eliminate the electric current ripples in the loops. The two bridge arms are connected to the two primary loops and the two secondary loops, and configured to control charge-discharge states of the two primary loops and the two secondary loops. In this way, a purpose of optimizing the topological structure of the interleaved buck converter is achieved. Therefore, the technical effects of reducing the excessive large current stress of the switches in the interleaved buck converter and enhancing the operation efficiency of the interleaved buck converter can be realized, thereby resolving the technical problems of excessive large current stress of the switches in the interleaved buck converter and low operation efficiency and fault tolerance of the interleaved buck converter in the related art.

As at least one alternative embodiment, the topological structure of the two-phase stacked interleaved buck converter may be, but is not limited to, applicable to a buck circuit, a boost circuit, and a z-source conversion circuit.

As at least one alternative embodiment, in the topological structure of the three-phase stacked interleaved buck converter still as shown in FIG. 17a, L₂₁ and L₂₂ are two primary loops, and L₁₁ and L₁₂ are two secondary loops. S₁₁, S₁₂, and S₁₃ correspond to the first bridge arm; and S₂₁, S₂₂, and S₂₃ correspond to the second bridge arm. The two primary loops are connected in parallel and configured to reduce an average current flowing through the inductor. Since the two primary loops L₂₁ and L₂₂ are connected in parallel, a total output current is shunted, so that large current output may be achieved, the average current flowing through the inductor may be reduced, and current stress flowing through the switches may also be reduced. In addition, the fault tolerance of a circuit is improved. When some bridge arm fails, other bridge arms may continue to operate, thereby enhancing the efficiency of the entire buck converter.

Each of the two bridge arms includes: three bridge arm switches, configured to control the charge-discharge states of the two primary loops and the two secondary loops based on switch states of the bridge arm switches. The three bridge arm switches cannot be in an off state at the same time.

As at least one alternative embodiment, the number of bridge arm switches on each of the two bridge arms is the same, and time periods that different bridge arm switches disposed on each bridge arm are in an off state are different. The same bridge arm is connected to one primary loop and the secondary loop corresponding to the other primary loop.

As at least one alternative embodiment, a switch sequence of bridge arm switches of the topological structure is

$$[ \begin{matrix}{S}_{11} & {S}_{21} \\ {S}_{12} & {S}_{22} \\ {S}_{13} & {S}_{23}\end{matrix} ] .$$

S₁₁, S₁₂, and S₁₃ are first bridge arm switches, and S₂₁, S₂₂, and S₂₃ are second bridge arm switches. S₁₁ and S₂₁ are configured to control a charge state of the number of the primary loops or the number of the secondary loops, S₁₂ and S₂₂ are configured to control the charge state of the number of the primary loops and a discharge state of the number of the secondary loops, and S₁₃ and S₂₃ are configured to control a discharge state of the number of the primary loops or the number of the secondary loops.

As at least one alternative embodiment, when Sᵢⱼ=1(i=1, 2; j=1, 2, 3), the bridge arm switch is in a closed state; and when Sᵢⱼ=0, the bridge arm switch is in a disconnected state. The method includes: if a target phase primary loop is in a charge state, a state of the bridge arm switch connected to the target phase primary loop is

$$[ \begin{matrix}1 \\ 1 \\ 0\end{matrix} ] ,$$

a state of the bridge arm switch connected to a target secondary loop is

$$[ \begin{matrix}0 \\ 1 \\ 1\end{matrix} ] .$$

As an optional embodiment, FIG. 17b is a schematic diagram of a topological structure of an optional two-phase stacked interleaved buck converter according to an embodiment of the present disclosure. As shown in FIG. 17b, when the first phase primary loop Lp1 is charged, the second bridge arm switches S₂₁ and S₂₂ are controlled to close, and S₂₃ is controlled to disconnect. In this case, the switch state of the bridge arm is

$$[ \begin{matrix}{S}_{11} & 1 \\ {S}_{12} & 1 \\ {S}_{13} & 0\end{matrix} ] .$$

Since the second phase secondary loop Ls2 is connected to the second bridge arm, the second phase secondary loop Ls2 is determined to be in a charge state. Based on the principle that the same phase primary and secondary loops have different charge-discharge states, the first phase secondary loop Ls1 is determined to be in a discharge state, the first bridge arm switch S₁₁ is controlled to disconnect, and S₁₂ and S₁₃ are controlled to close. In this case, the switch state of the bridge arm is

$$[ \begin{matrix}0 & 1 \\ 1 & 1 \\ 1 & 0\end{matrix} ] ,$$

and the second phase primary loop Lp1 is simultaneously determined to be in a charge state.

As an optional embodiment, FIG. 17c is a schematic diagram of a topological structure of an optional two-phase stacked interleaved buck converter according to an embodiment of the present disclosure. As shown in FIG. 17c, when the second phase primary loop Lp2 is charged, the first bridge arm switches S₁₁ and S₁₂ are controlled to close, and S₁₃ is controlled to disconnect. In this case, the switch state of the bridge arm is

$$[ \begin{matrix}1 & {S}_{21} \\ 1 & {S}_{22} \\ 0 & {S}_{23}\end{matrix} ] .$$

Since the first phase secondary loop Ls1 is connected to the first bridge arm, the first phase secondary loop Ls1 is determined to be in a charge state. Based on the principle that the same phase primary and secondary loops have different charge-discharge states, the second phase secondary loop Ls2 is determined to be in a discharge state, the second bridge arm switches S₂₂ and S₂₃ are controlled to close, and S₂₁ is controlled to disconnect. In this case, the switch state of the bridge arm is

$$[ \begin{matrix}1 & 0 \\ 1 & 1 \\ 1 & 0\end{matrix} ] ,$$

and the first phase primary loop Lp1 is simultaneously determined to be in a charge state.

As an optional embodiment, FIG. 17d is a schematic diagram of a topological structure of an optional two-phase stacked interleaved buck converter according to an embodiment of the present disclosure. As shown in FIG. 17d, if both the first phase primary loop and the second phase primary loop (that is, Lp1 and Lp2) are in a discharge state, and based on the principle that the same phase primary and secondary loops have different charge-discharge states, both the first phase secondary loop and the second phase secondary loop (that is, Ls1 and Ls2) are determined to be in a charge state. The first bridge arm switches S₁₁ and S₁₃ are controlled to close, and S₁₂ is controlled to disconnect. The second bridge arm switches S₂₁ and S₂₃ are controlled to close, and S₂₂ is controlled to disconnect. In this case, the switch state of the bridge arm is

$$[ \begin{matrix}1 & 1 \\ 0 & 0 \\ 1 & 1\end{matrix} ] .$$

It is to be noted that, for ease of simple description, the foregoing method embodiments are all expressed as a series of action combinations, but those skilled in the art should know that the present disclosure is not limited by the described action sequence, as according to the present disclosure, some steps may be performed in other sequences or simultaneously. Then, those skilled in the art should also know that the embodiments described in the specification are all preferred embodiments, and the actions and modules involved are not necessarily required by the present disclosure.

From the above descriptions about the implementation modes, those skilled in the art may clearly know that the method according to the foregoing embodiments may be implemented in a manner of combining software and a necessary universal hardware platform, and of course, may also be implemented through hardware, but the former is a preferred implementation mode under many circumstances. Based on such an understanding, the technical solutions of the present disclosure substantially or parts making contributions to the conventional art may be embodied in form of software product, and the computer software product is stored in a storage medium (for example, a ROM/RAM), a magnetic disk and an optical disk), including a plurality of instructions configured to enable a terminal device (which may be a mobile phone, a computer, a server, a network device, or the like) to execute the method in each embodiment of the present disclosure.

### Embodiment 5

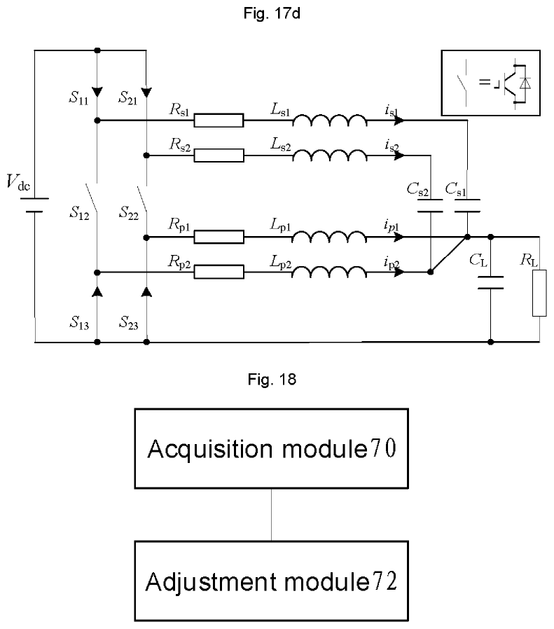

An embodiment of the present disclosure further provides an apparatus embodiment for implementing the method for modulating a switch of a converter. FIG. 18 is a schematic structural diagram of an apparatus for modulating a switch of a converter according to an embodiment of the present disclosure. As shown in FIG. 18, the apparatus for modulating a switch of a converter includes an acquisition module 70 and an adjustment module 72.

The acquisition module 70 is configured to acquire charge-discharge state information in the topological structure. The charge-discharge state information includes at least a first charge-discharge state of any one phase primary loop, a second charge-discharge state of a secondary loop corresponding to any one phase primary loop, a third charge-discharge state of another primary loop, and a fourth charge-discharge state of another secondary loop. The adjustment module 72 is configured to adjust, based on the first charge-discharge state, a closed state of a switch disposed on a bridge arm connected to any one phase primary loop, and adjust, based on the second charge-discharge state and the third charge-discharge state, a closed state of a switch disposed on another bridge arm.

It is to be noted that, each of the above modules may be implemented by software or hardware. For example, for the latter, it may be implemented in the following manners: the above modules are all located in a same processor; or the above modules are located in different processors in any combination.

It is to be noted here that, the acquisition module 70 and the adjustment module 72 correspond to S102 to S104 in Embodiment 1, examples and application scenarios implemented by the above modules and the corresponding steps are the same, but are not limited to the contents disclosed in Embodiment 1. It is to be noted that, the above modules are used as a part of the apparatus, and may be operated in a computer terminal.

It is to be noted that, for optional or preferred implementations of this embodiment, refer to the relevant descriptions in Embodiment 1, which are not described herein again.

The apparatus for modulating a switch of a converter may further includes a processor and a memory. The acquisition module 70 and the adjustment module 72 are all stored in the memory as program units, and the processor executes the program units stored in the memory to implement corresponding functions.

The processor includes a kernel, and the kernel invokes the corresponding program unit from the memory, and one or more of the above kernels may be disposed. The memory may include a non-persistent memory in a computer-readable medium, a Random Access Memory (RAM) and/or a non-volatile memory, for example, a Read Only Memory (ROM) or a flash memory (flash RAM). The memory includes at least one memory chip.

An embodiment of the present disclosure further provides an embodiment of a non-volatile storage medium. As at least one alternative embodiment, in this embodiment, the non-volatile storage medium includes a stored program. When the program is operated, a device where the non-volatile storage medium is located is controlled to execute any of the above method for modulating a switch of a converter.

As at least one alternative embodiment, in this embodiment, the non-volatile storage medium may be located in any computer terminal in a computer terminal group in a computer network, or located in any mobile terminal in a mobile terminal group. The non-volatile storage medium includes the stored program.

As at least one alternative embodiment, when the program is operated, the device where the non-volatile storage medium is located is controlled to perform the following functions. The charge-discharge state information in the topological structure is acquired. The charge-discharge state information includes at least the first charge-discharge state of any one phase primary loop, the second charge-discharge state of the secondary loop corresponding to any one phase primary loop, the third charge-discharge state of another primary loop, and the fourth charge-discharge state of another secondary loop. The closed state of the switch disposed on the bridge arm connected to any one phase primary loop is adjusted based on the first charge-discharge state, and the closed state of the switch disposed on another bridge arm is adjusted based on the second charge-discharge state and the third charge-discharge state.

An embodiment of the present disclosure further provides an embodiment of a processor. As at least one alternative embodiment, in this embodiment, the processor is configured to operate a program. When the program is operated, any of the above method for modulating a switch of a converter is executed.

An embodiment of the present disclosure further provides an embodiment of a computer program product. When being executed on a data processing device, the computer program product is adapted to execute a program initialized with steps of any of the above method for modulating a switch of a converter.

As at least one alternative embodiment, when being executed on the data processing device, the computer program product is adapted to execute the program initialized with the following method steps: acquiring charge-discharge state information in the topological structure, where the charge-discharge state information includes at least a first charge-discharge state of any one phase primary loop, a second charge-discharge state of a secondary loop corresponding to any one phase primary loop, a third charge-discharge state of another primary loop, and a fourth charge-discharge state of another secondary loop; and adjusting, based on the first charge-discharge state, a closed state of a switch disposed on a bridge arm connected to any one phase primary loop, and adjusting, based on the second charge-discharge state and the third charge-discharge state, a closed state of a switch disposed on another bridge arm.

An embodiment of the present disclosure further provides an embodiment of an electronic device, including a memory and a processor. The memory stores a computer program. The processor is configured to run the computer program to execute any of the above method for modulating a switch of a converter.

The serial numbers of the foregoing embodiments of the present disclosure are merely for description, and do not represent the superiority or inferiority of the embodiments.

In the above embodiments of the present disclosure, the description of the embodiments has its own focus. For parts that are not described in detail in a certain embodiment, reference may be made to related descriptions of other embodiments.

In the several embodiments provided in this application, it should be understood that, the disclosed technical content can be implemented in other ways. The apparatus embodiments described above are merely illustrative. For example, the division of the units may be a logical function division, and there may be other divisions in actual implementation. For example, a plurality of units or components may be combined or integrated into another system, or some features can be ignored, or not implemented. In addition, the displayed or discussed mutual coupling or direct coupling or communication connection may be indirect coupling or communication connection through some interfaces, units or modules, and may be in electrical or other forms.

The units described as separate components may or may not be physically separated. The components displayed as units may or may not be physical units, that is, the components may be located in one place, or may be distributed on the plurality of units. Part or all of the units may be selected according to actual requirements to achieve the purposes of the solutions of this embodiment.

In addition, the functional units in the various embodiments of the present disclosure may be integrated into one processing unit, or each unit may exist alone physically, or two or more than two units may be integrated into one unit. The above integrated unit can be implemented in the form of hardware, or can be implemented in the form of a software functional unit.

If the integrated unit is implemented in the form of the software functional unit and sold or used as an independent product, it can be stored in the computer-readable non-volatile storage medium. Based on this understanding, the technical solutions of the present disclosure essentially or the parts that contribute to the related art, or all or part of the technical solutions can be embodied in the form of a software product. The computer software product is stored in a non-volatile storage medium, including a plurality of instructions for causing a computer device (which may be a personal computer, a server, or a network device, and the like) to execute all or part of the steps of the method described in the various embodiments of the present disclosure. The foregoing non-volatile storage medium includes a USB flash disk, a Read-Only Memory (ROM), a Random Access Memory (RAM), and various media that can store program codes, such as a mobile hard disk, a magnetic disk, or an optical disk.

The above description is merely preferred implementations of the present disclosure, and it should be noted that persons of ordinary skill in the art may also make several improvements and refinements without departing from the principle of the present disclosure, and it should be considered that these improvements and refinements shall all fall within the protection scope of the present disclosure.

What is claimed is:

1. A method for modulating a switch of a converter, applicable to a multiphase stacked interleaved buck converter, wherein a topological structure of the multiphase stacked interleaved buck converter comprises a first number of primary loops, the first number of secondary loops, and the first number of bridge arms, each bridge arm is provided with a second number of switches, and the method comprises:
acquiring charge-discharge state information in the topological structure, wherein the charge-discharge state information comprises at least a first charge-discharge state of any one phase primary loop, a second charge-discharge state of a secondary loop corresponding to the any one phase primary loop, a third charge-discharge state of another primary loop, and a fourth charge-discharge state of another secondary loop; and
adjusting, based on the first charge-discharge state, a closed state of a switch disposed on a bridge arm connected to the any one phase primary loop, and adjusting, based on the second charge-discharge state and the third charge-discharge state, a closed state of a switch disposed on another bridge arm.

2. The method according to claim 1, wherein the acquiring charge-discharge state information in the topological structure comprises:
determining the second charge-discharge state, the third charge-discharge state, and the fourth charge-discharge state based on the first charge-discharge state and a connection relationship between each loop and the first number of bridge arms, wherein the first charge-discharge state is same as the fourth charge-discharge state, and both the second charge-discharge state and the third charge-discharge state are opposite to the first charge-discharge state.

3. The method according to claim 2, applicable to a topological structure of a three-phase stacked interleaved buck converter, wherein a sequence of switches disposed on the first number of bridge arms of the topological structure is
$$[ \begin{matrix}{S}_{11} & {S}_{21} & {S}_{31} \\ {S}_{12} & {S}_{22} & {S}_{32} \\ {S}_{13} & {S}_{23} & {S}_{33}\end{matrix} ] ,$$
wherein
S₁₁, S₁₂, and S₁₃ are first bridge arm switches, S₂₁, S₂₂, and S₂₃ are second bridge arm switches, and S₃₁, S₃₂, and S₃₃ are third bridge arm switches; S₁₂, S₂₁, and S₃₁ are configured to control a charge state of the number of the primary loops or the number of the secondary loops, S₁₂, S₂₂, and S₃₂ are configured to control the charge state of the number of the primary loops and a discharge state of the number of the secondary loops, and S₁₃, S₂₃, and S₃₃ are configured to control a discharge state of the number of the primary loops or the number of the secondary loops.

4. The method according to claim 3, the method further comprising:
acquiring charge state information of a first phase primary loop, controlling the second bridge arm switches S₂₁, and S₂₂ to close and S₂₃ to disconnect, and simultaneously determining that a second phase secondary loop is in a charge state;
determining, based on the charge state information of the first phase primary loop, that a first phase secondary loop is in a discharge state and a third phase primary loop is in a discharge state, and controlling the first bridge arm switches S₁₂ and S₁₃ to close and S₁₁ to disconnect; and
determining, based on the charge state information of the first phase primary loop and discharge state information of the first phase secondary loop, that a second phase primary loop is in a discharge state and a third phase secondary loop is in a charge state, and controlling the third bridge arm switches S₃₁ and S₃₃ to close and S₃₂ to disconnect.

5. The method according to claim 3, the method further comprising:
acquiring the charge state information of the second phase primary loop, controlling the third bridge arm switches S₃₁ and S₃₂ to close and S₃₃ to disconnect, and simultaneously determining that the third phase secondary loop is in a charge state;
determining, based on the charge state information of the second phase primary loop, that the second phase secondary loop is in a discharge state and the first phase primary loop is in a discharge state, and controlling the second bridge arm switches S₂₂ and S₂₃ to close and S₂₁ to disconnect; and
determining, based on the charge state information of the second phase primary loop and the discharge state information of the second phase secondary loop, that the third phase primary loop is in a discharge state and the first phase secondary loop is in a charge state, and controlling the first bridge arm switches S₁₁ and S₁₃ to close and S₁₂ to disconnect.

6. The method according to claim 3, the method further comprising:
acquiring the charge state information of the third phase primary loop, controlling the first bridge arm switches S₁₁ and S₁₂ to close and S₁₃ to disconnect, and simultaneously determining that the first phase secondary loop is in a charge state;
determining, based on the charge state information of the third phase primary loop, that the third phase secondary loop is in a discharge state and the second phase primary loop is in a discharge state, and controlling the third bridge arm switch S₃₁ to disconnect and S₃₂ and S₃₃ to close; and
determining, based on the charge state information of the third phase primary loop and the discharge state information of the third phase secondary loop, that the first phase primary loop is in a discharge state and the second phase secondary loop is in a charge state, and controlling the second bridge arm switches S₂₁ and S₂₃ to close and S₂₂ to disconnect.

7. The method according to claim 3, the method further comprising:
determining that a first phase secondary loop, a second phase secondary loop, and a third phase secondary loop are all in a charge state when a first phase primary loop, a second phase primary loop, and a third phase primary loop are all in a discharge state; controlling the first bridge arm switches S₁₁ and S₁₃ to close and S₁₂ to disconnect; controlling the second bridge arm switches S₂₁ and S₂₃ to close and S₂₂ to disconnect; and controlling the third bridge arm switches S₃₁ and S₃₃ to close and S₃₂ to disconnect.

8. The method according to claim 2, applicable to a two-phase stacked interleaved buck converter, wherein a switch sequence of the bridge arm switches of the topological structure of the two-phase stacked interleaved buck converter is
$$[ \begin{matrix}{S}_{11} & {S}_{21} \\ {S}_{12} & {S}_{22} \\ {S}_{13} & {S}_{23}\end{matrix} ] ,$$
wherein
S₁₁, S₁₂, and S₁₃ are first bridge arm switches, and S₂₁, S₂₂, and S₂₃ are second bridge arm switches; S₁₁ and S₂₁ are configured to control a charge state of the number of the primary loops or the number of the secondary loops, S₁₂ and S₂₂ are configured to control the charge state of the number of the primary loops and a discharge state of the number of the secondary loops, and S₁₃ and S₂₃ are configured to control a discharge state of the number of the primary loops or the number of the secondary loops.

9. The method according to claim 8, the method further comprising:
acquiring charge state information of a first phase primary loop, controlling the second bridge arm switches S₂₁ and S₂₂ to close and S₂₃ to disconnect, and simultaneously determining that a second phase secondary loop is in a charge state; and
determining, based on the charge state information of the first phase primary loop, that the first phase secondary loop is in a discharge state and the second phase primary loop is in a discharge state, and controlling the first bridge arm switch S₁₁ to disconnect and S₁₂ and S₁₃ to close.

10. The method according to claim 8, the method further comprising:
acquiring the charge state information of the second phase primary loop, controlling the first bridge arm switches S₁₁ and S₁₂ to close and S₁₃ to disconnect, and simultaneously determining that the first phase secondary loop is in a charge state; and
determining, based on the charge state information of the second phase primary loop, that the second phase secondary loop is in a discharge state and the first phase primary loop is in a discharge state, and controlling the second bridge arm switches S₂₂ and S₂₃ to close and S₂₁ to disconnect.

11. The method according to claim 8, the method further comprising:
determining that both the first phase secondary loop and the second phase secondary loop are in a charge state if both the first phase primary loop and the second phase primary loop are in a discharge state; controlling the first bridge arm switches S₁₁ and S₁₃ to close and S₁₂ to disconnect; and controlling the second bridge arm switches S₂₁ and S₂₃ to close and S₂₂ to disconnect.

12. The method according to claim 3, wherein, when Sᵢⱼ=1(i=1, 2, 3; j=1, 2, 3), the bridge arm switches are in the closed state; and when Sᵢⱼ=0, the bridge arm switches are in a disconnected state, comprising:
if a target phase primary loop is in a charge state, a state of the bridge arm switch connected to the target phase primary loop is
$$[ \begin{matrix}1 \\ 1 \\ 0\end{matrix} ] ,$$
a state of the bridge arm switch connected to a target secondary loop is
$$[ \begin{matrix}0 \\ 1 \\ 1\end{matrix} ] ,$$
and a switch state of another bridge arm is
$$[ \begin{matrix}1 \\ 0 \\ 1\end{matrix} ] .$$

13. The method according to claim 4, wherein, when Sᵢⱼ=1(i=1, 2, 3; j=1, 2, 3), the bridge arm switches are in the closed state; and when Sᵢⱼ=0, the bridge arm switches are in a disconnected state, comprising:
if a target phase primary loop is in a charge state, a state of the bridge arm switch connected to the target phase primary loop is
$$[ \begin{matrix}1 \\ 1 \\ 0\end{matrix} ] ,$$
a state of the bridge arm switch connected to a target secondary loop is
$$[ \begin{matrix}0 \\ 1 \\ 1\end{matrix} ] ,$$
and a switch state of another bridge arm is
$$[ \begin{matrix}1 \\ 0 \\ 1\end{matrix} ] .$$

14. A multiphase stacked interleaved buck converter, comprising:
a first number of primary loops;
a first number of secondary loops, connected to the first number of primary loops and configured to eliminate electric current ripples in the loops; and
a first number of bridge arms, connected to the first number of primary loops and the first number of secondary loops, and configured to control charge-discharge states of the first number of primary loops and the first number of secondary loops.

15. The multiphase stacked interleaved buck converter according to claim 14, wherein the first number of bridge arms comprise:
a second number of bridge arm switches, configured to control the charge-discharge states of the first number of primary loops and the first number of secondary loops based on switch states of the bridge arm switches.

16. The multiphase stacked interleaved buck converter according to claim 15, wherein the first number of bridge arms comprise:
the number of bridge arm switches on each bridge arm is same, and time periods that different bridge arm switches disposed on each bridge arm are in an off state are different.

17. The multiphase stacked interleaved buck converter according to claim 16, further comprising:
each primary loop comprises at least an inductor, wherein the inductor and a load are serially connected to the primary loop; and
each primary loop comprises at least the inductor and a capacitor, wherein the inductor and the capacitor are serially connected to the secondary loop.

18. The multiphase stacked interleaved buck converter according to claim 17, further comprising:
the electric current ripple is further configured to determine an inductance parameter of the inductor within a target time period, and an equation of the electric current ripple within the target time period is
$$Δ i = \frac{D ( 1 - D )}{fL} {V}_{IN} ,$$
wherein Δi is the electric current ripple, D is a duty cycle of the multiphase stacked interleaved buck converter, f is a switching frequency of a switch of the multiphase stacked interleaved buck converter, L is the inductor, and V_{IN} is an input voltage of the multiphase stacked interleaved buck converter.

19. A three-phase stacked interleaved buck converter, comprising:
three primary loops;
three secondary loops, connected to the three primary loops and configured to eliminate electric current ripples in the loops; and
three bridge arms, connected to the three primary loops and the three secondary loops, and configured to control charge-discharge states of the three primary loops and the three secondary loops.

20. The three-phase stacked interleaved buck converter according to claim 19, wherein each of the three bridge arms comprises:
three bridge arm switches, configured to control the charge-discharge states of the three primary loops and the three secondary loops based on switch states of the bridge arm switches, wherein the three bridge arm switches are not allowed to be in an off state at the same time.
